(19) United States
(12) Patent Application Publication
(10) Pub. No.: US 2023/0057546 A1
(43) Pub. Date: Feb. 23, 2023

(54) TILT INDICATOR

(71) Applicant: ShockWatch, Inc., Dallas, TX (US)

(72) Inventors: Anthony N. Fonk, Austin, TX (US); Angela K. Kerr, Plano, TX (US)

(21) Appl. No.: 17/890,780

(22) Filed: Aug. 18, 2022

Related U.S. Application Data
(60) Provisional application No. 63/234,280, filed on Aug. 18, 2021.

(51) Int. Cl. G01C 9/10; G01C 9/06

(52) U.S. Cl. CPC G01C 9/10; G01C 9/06; G01C 2009/102

(57) ABSTRACT

A tilt indicator includes a housing having a face member and a back member. A movable mass member is disposed within the housing between the face member and the back member. A first encoded indicium is disposed on the mass member, and a second encoded indicium is located on the back member. In response to the tilt indicator being subjected to a tilt event exceeding a threshold, the mass member moves from a first position to a second position.

### BACKGROUND

During manufacturing, storage, transit, or usage, many types of objects need to be monitored or tracked due to the tilt sensitivity or fragility of the objects. For example, in today's global economy, goods, materials, manufactured articles, and the like are often transported great distances before reaching their final destination. The shipping process may involve multiple transportation methods. For instance, it is not uncommon for a product manufactured in Asia, to be loaded on a truck, transported to a rail station, loaded onto a railcar, transported by rail to a port, loaded onto a cargo ship, transported overseas to a port, loaded onto a truck, transported over road by truck, and delivered to a warehouse. Once at the warehouse, the product may again be shipped via air or ground before reaching the ultimate user of the product. During this process, the product may be loaded and unloaded many times and may be occasionally damaged as a result of handling mishaps. Some products are susceptible to damage if they are not transported in a certain position. For example, some computer hard drives are known to malfunction if they are turned on their sides or upside down. Thus, some types of objects may be susceptible to damage if upended, turned over, or tilted at greater than a predetermined angle. Thus, for quality control purposes and/or the general monitoring of transportation conditions, it is desirable to determine and/or verify the environmental conditions an object has experienced.

### BRIEF SUMMARY

According to one aspect of the present disclosure, a tilt indicator includes a housing having a face member and a back member. A movable mass member is disposed within the housing between the face member and the back member. A first encoded indicium is disposed on the mass member, and a second encoded indicium is located on the back member. In response to the tilt indicator being subjected to a tilt event exceeding a threshold, the mass member moves from a first position to a second position.

According to another embodiment of the present disclosure, a tilt indicator includes a housing having a face member, a back member, and a window. A movable mass member is disposed within the housing between the face member and the back member. Responsive to the tilt indicator being subjected to a tilt event exceeding a threshold, the mass member moves from a first position to a second position. The tilt indicator also includes a first encoded indicium and a second encoded indicium where the first and second encoded indicia are aligned with the window in an unactivated state of the tilt indicator.

According to yet another embodiment of the present disclosure, a tilt indicator includes a housing having a face member, a back member, and a window. A movable mass member is disposed within the housing between the face member and the back member. A first encoded indicium is disposed on the mass member, and a second encoded indicium is disposed on the back member. Responsive to the tilt indicator being subjected to a tilt event exceeding a threshold, the mass member moves from a first position to a second position, and wherein either the first encoded indicium or the second encoded indicium is exposed through the window based on a position of the mass member within the housing.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is a diagram illustrating an application of an embodiment of a tilt indicator according to the present disclosure;

FIG. 2 is a diagram illustrating an embodiment of a tilt indicator in accordance with the present disclosure in an unactivated state;

FIG. 3 is a diagram illustrating a section view of a portion of the tilt indicator of FIG. 2 along the line 3-3 of FIG. 2 according to the present disclosure; and

FIG. 4 is a diagram illustrating the embodiment of the tilt indicator of FIGS. 2 and 3 in accordance with the present disclosure in an activated state.

### DETAILED DESCRIPTION

Embodiments of the present disclosure provide a device and technique for tilt detection and indication. According to one embodiment, a tilt indicator includes having a face member and a back member. A movable mass member is disposed within the housing between the face member and the back member. A first encoded indicium is disposed on the mass member, and a second encoded indicium is located on the back member. In response to the tilt indicator being subjected to a tilt event exceeding a threshold, the mass member moves from a first position to a second position. The encoded indicia are each located to be viewable through a window of the indicator such that a different one of the indicia is viewable through the window based on whether the tilt indicator has experienced a tilt event.

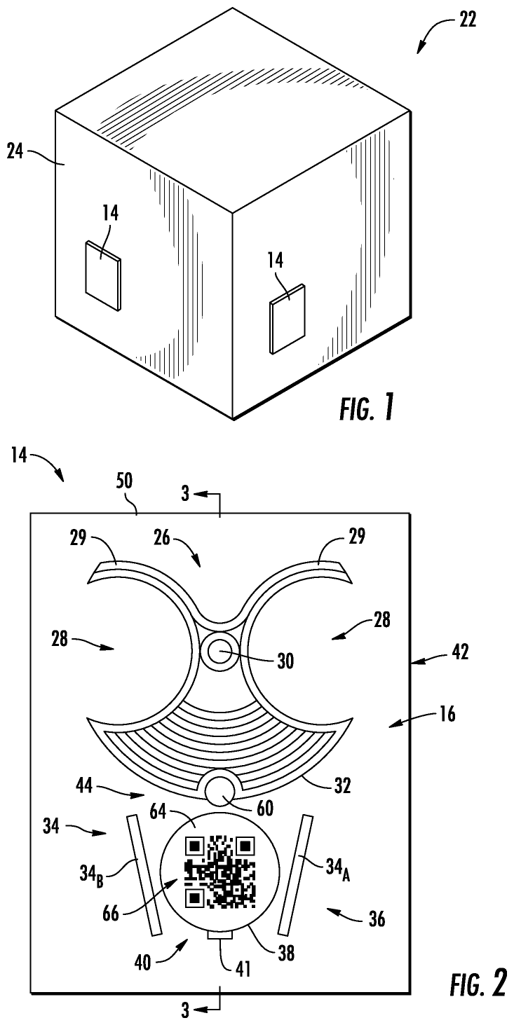

With reference now to the Figures and in particular with reference to FIG. 1, exemplary diagrams of a tilt indicator are provided. Referring to FIG. 1, an object, such as a shipping package 22, has one or more tilt indicators 14 affixed on one or more walls 24 thereof for determining whether the package has been maintained in its recommended orientation during shipment and not tilted beyond a predetermined maximum angle. The shipping package 22 may be of any of the conventional form, such as crates, pallets, boxes, cartons, barrels, drums, cans, bottles or other containers emplaced about the goods before shipping. Alternatively, tilt indicator(s) 14 could be placed directly onto the goods themselves. Thus, an object bearing tilt indicator 14 could be goods, a container bearing goods, etc. In order to detect unauthorized tilting, tilt indicator 14 is preferably placed on an upright or side wall 24 of the shipping package 22 when in the upright position. In some embodiments, tilt indicator 14 is sensitive in two dimensions, namely in the plane of indicator 14 (e.g., a plane corresponding to wall 24). Thus, tilt indicator 14 may be used in combination with another tilt indicator 14 placed on an adjacent side wall 24 of the package 22 wherein the two tilt indicators 14 are transverse to one another.

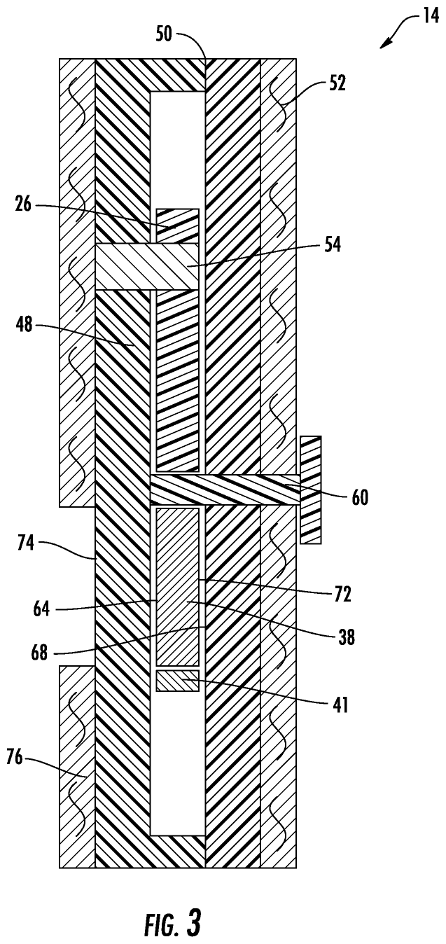

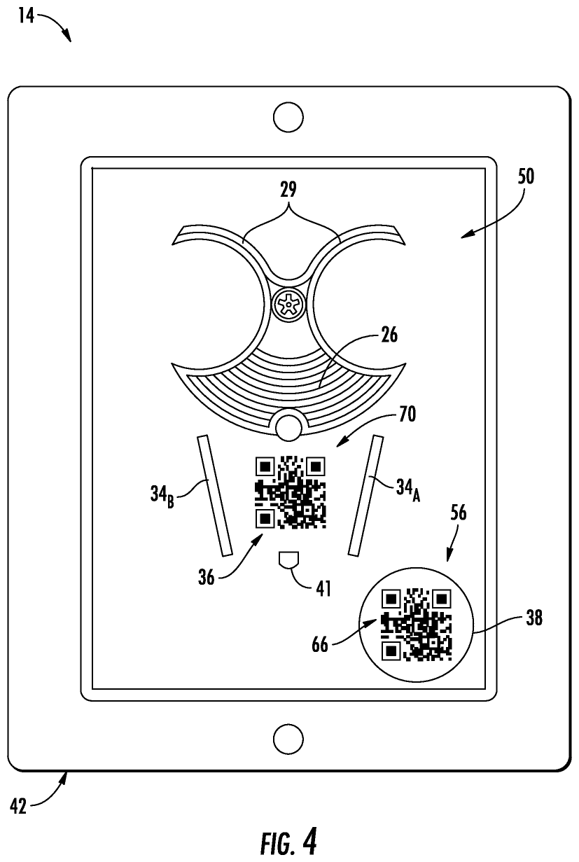

Referring to FIGS. 2-4, FIG. 2 is a diagram illustrating an embodiment of tilt indicator 14 in accordance with the present disclosure in an unactivated state. FIG. 3 is a diagram illustrating a section view of the tilt indicator of FIG. 2 taken along the line 3-3 of FIG. 2 in accordance an embodiment of the present disclosure, and FIG. 4 is a diagram illustrating the embodiment of the tilt indicator 14 of FIGS. 2 and 3 in accordance with the present disclosure in an activated state. The mechanical operation of tilt indicator 14 is similar to the commercially available tilt indicator Tilt Watch XTR available from SpotSee of Dallas, Tex., and also described more fully in U.S. Pat. No. 7,353,615 which is incorporated, in its entirety, herein by reference.

In FIGS. 2-4, tilt indicator 14 has a container or housing 42 supporting a tilt detection assembly 16 including a receptacle 36 adjacent to a base plate or back member 50. The receptacle 36 is formed by a plurality of walls 34 (e.g., walls 34A and 34B) that has a closed end 40 and an open end 44, and where the walls 34A and 34B extend between the closed end 40 and open end 44. Walls 34A and 34B face a disc or mass member 38 of tilt detection assembly 16. Receptacle 36, which may also be referred to as a retaining receptacle, receives mass member 38 therein. In some embodiments, mass member 38 is configured as a circular disc because tilt indicator 14 is configured having a thin profile.

In the illustrated embodiment, receptacle 36 is configured in the form of a V-shape or flared horseshoe shape with closed end 40 of the V or horseshoe located near the base of tilt indicator 14. In the illustrated embodiment, the closed end 40 includes a stop member 41 to prevent the mass member 38 from exiting the lower portion of the receptacle 36. Open end 44 is located above closed end 40 when indicator 14 is in the upright, or vertical, position. Walls 34A and 34B of the V or horseshoe extend from closed end 40 of receptacle 36 at angles relative to one another so as to allow mass member 38 to rest within the cavity formed by walls 34A and 34B and to escape receptacle 36 when tilt indicator 14 is inclined beyond a predetermined angle. In the normal, upright orientation of tilt indicator 14, mass member 38 is located inside of receptacle 36 in an unactivated state of the tilt indicator 14. When receptacle 36 is tilted beyond a predetermined angle (e.g., a predetermined level of tilt or a tilt event exceeding some threshold), mass member 38 exits receptacle 36 (FIG. 4), thereby indicating an activated state of tilt indicator 14. In some embodiments, this angle is generally the angle at which one of walls 34A or 34B is oriented at or below horizontal. For example, when indicator 14 is tilted to say, 80 degrees from its upright orientation, then mass member 38 can exit receptacle 36. The slope or angle of the walls 34A and 34B determines the angle at which indicator 14 will become activated. Accordingly, the slope or angle of the walls 34A and 34B may be varied to a desired angle of indicator 14 activation. Further, in the illustrated embodiment, indicator 14 is bi-directional and is activated by tilting indicator 14 beyond the predetermined angle towards either of walls 34A or 34B of receptacle 36.

Receptacle 36 is located within housing 42 and, in some embodiments, housing 42 is configured having a thin profile. Accordingly, in this embodiment, mass member 38 can only move in two dimensions, for practical purposes (there may be some minimal movement in a third dimension (e.g., between back member 50 and the face of housing 42 (not expressly shown in FIG. 2).

Occasionally, mass member 38 will move in response to vibrational frequencies to which mass member 38 is sensitive or responsive. This movement could in some cases cause mass member 38 to escape from receptacle 36 even in the absence of receptacle 36 tilting, resulting in a false indication of tilting. In order to prevent such a false indication under this set of vibrational frequencies, tilt detection assembly 16 is configured such that the exit of receptacle 36 by mass member 38 is blocked by a hanging mass 26 of tilt detection assembly 16. Hanging mass 26 is suspended adjacent to open end 44 and has a pivot point 30 around which hanging mass 26 pivots in a plane parallel with member 50 and/or mass member 38. When receptacle 36 is in its normal, untilted or unactivated orientation, hanging mass 26 blocks the exit of mass member 38 from receptacle 36. Thus, even if vibration moves mass member 38 toward open end 44, tilt indicator 14 does not activate. Hanging mass 26 is generally not sensitive or responsive to the same vibrational frequencies as mass member 38. Instead, hanging mass 26 is responsive to a second, different set of vibrational frequencies. Hanging mass 26, while preventing false activation, does not interfere with normal operation of indicator 14. When receptacle 36 is tilted beyond the predetermined angle, hanging mass 26 moves so as to allow mass member 38 to exit receptacle 36. A tilting indication or activation occurs when mass member 38 has exited receptacle 36.

Hanging mass 26 has at least two lateral wings 29 or arms located above a blocking portion 32 of mass 26, as shown in FIG. 2. Wings 29 are located on the opposite side of pivot point 30 from the blocking portion 32 and form lateral cavities 28 at least slightly larger than the diameter of mass member 38. Although the illustrated embodiment has lateral cavities 28, tilt indicator 14 without lateral cavities 28 will prevent the escape of mass member 38 in the presence of vibrational frequencies to which mass member 38 is sensitive.

Once mass member 38 exits receptacle 36 and enters the exposed lateral cavity 28 of hanging mass 26, the weight of mass member 38 within the lateral cavity 28 will further cause hanging mass 26 to pivot. Mass member 38 will then fall from the lateral cavity 28 into the non-receptacle part of the housing 42 (e.g., an area 56). Once the shipping package 22 is re-oriented to the upright position, hanging mass 26 returns to the blocking position depicted in FIG. 2 and mass member 38 remains outside the retaining receptacle 36 within the area 56.

Thus, hanging mass 26 acts as a pendulum, maintaining its orientation due to gravity. When receptacle 36 is upright, hanging mass 26 blocks open end 44 of receptacle 36. When tilt indicator 14 is tilted, hanging mass 26 moves and no longer blocks open end 44. Wings 29 of hanging mass 26 prevent reentry of mass member 38 upon escape of mass member 38 from receptacle 36.

In order to make tilt indicator 14 field armable so that tilt indicator 14 is prevented from being activated until ready, a removable retaining device such as an arming pin 60 is provided, as shown in FIG. 3. Arming pin 60 prevents mass member 38 from escaping receptacle 36 and remains in place until such time as pin 60 is removed and indicator 14 is placed into service.

The housing 42 of the tilt detector 14 has a face member 48 and the back member 50. As used herein the terms “forward” and “rearward” refer to relative positions of the tilt indicator 14 when placed on an object such that the term “forward” refers to portions of the tilt indicator 14 facing a user and “rearward” refers to portions of the tilt indicator 14 facing an object when the tilt indicator 14 is affixed to an object. For example, in FIG. 3, the “forward” direction is right-to-left. The face member 48 has a forward-facing transparent window 74, and the back member 50 has a layer of adhesive 52 disposed on a rearward surface thereof. Tilt indicator 14 also has a removable arming pin 60. In some embodiments, the window 74 is formed by an opening in a label 76 disposed on a forward surface of the face 48. However, it should be understood that the window 74 may also be configured as part of the face member 48 (e.g., a transparent portion of the face member 48 facing in the forward direction). Because the indicator 14 is thin, it has a low profile when attached to an object or shipping package 22 (FIG. 1).

In the embodiment illustrated, a forward-facing surface 64 of the mass member 38 includes a machine-readable encoded indicium 66, and a forward-facing surface 68 of the back member 50 includes a machine-readable encoded indicium 70. Encoded indicia 66 and 70 may comprise a barcode or other type of machine-readable indicium (e.g., a numeric code, an alphanumeric code, a quick response (QR) code or other type of encoded indicium) to indicate the activation or impact status of indicator 14 (e.g., a status identifier that may be encoded, machine-perceptible instead of human-perceptible). For example, the indicium 66 and 70 may each be a different designation such that one of indicium 66 or 70 indicates an unactivated state of the indicator 14 and the other one of indicium 66 or 70 indicates an activated state of the indicator 14. Indicia 66 and 70 may be applied to the respective surfaces 64 and 68 by etching, printed/adhered labels or decals, applied marking techniques, etc.

In the illustrated embodiment, indicia 66 and 70 are aligned with each other and aligned with the window 74 in the unactivated state of the indicator 14. For example, in the illustrated embodiment, in an unactivated state of the indicator 14, the forward-facing surface 64 of the mass member 38 is exposed through the window 74 such that the indicium 66 is exposed through the window 74. However, in the unactivated state of the indicator 14, the mass member 38 is disposed in front of the second indicium 70 (e.g., the indicium 70 facing a rearward surface 72 of the mass member 38), thereby blocking or hiding from view the second indicium 70 through the window 74. In response to indicator 14 being subjected to a tilt event, mass member 38 exits the receptacle 36 (e.g., moving from the receptacle 36 to the area 56), thereby unblocking the indicium 70 from being viewable through the window 74. The area 56 comprises an unexposed or hidden area within the housing 42 such that once the mass member 38 enters the area 56, the mass member 38, and correspondingly the indicium 66, are hidden from view to a user of the indicator 14 (e.g., an opaque portion of the housing 42 such that the area 56 is not visible through window 74 or through any other forward-facing portion of the housing 42).

Thus, in operation, in an unactivated state of indicator 14, mass member 38 (and indicium 66) are exposed through the window 74 and may be read by a barcode reader (not illustrated) or other type of device configured to detect and read the encoded indicium 66. As indicated above, with the mass member 38 in the unactivated position, indicium 70 is hidden from view through the window 74 by the mass member 38. In response to indicator 14 being subjected to a tilt event, mass member 38 exits the receptacle 36 (e.g., moving from the receptacle 36 to the area 56), thereby unblocking the indicium 70 from being viewable through the window 74. Thus, in operation, only one of indicium 66 or 70 is viewable through the window 74 based on whether the tilt indicator 14 has experienced a tilt event. Thus, without a device capable of reading a deciphering the indicia 66 and 70, the activation status of the indicator 14 may be imperceptible to a user.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A tilt indicator, comprising:
a housing having a face member and a back member;
a movable mass member disposed within the housing between the face member and the back member;
a first encoded indicium disposed on the mass member; and
a second encoded indicium located on the back member; and
wherein responsive to the tilt indicator being subjected to a tilt event exceeding a threshold, the mass member moves from a first position to a second position.

2. The tilt indicator of claim 1, wherein the first and second encoded indicia are machine-readable encoded indicia.

3. The tilt indicator of claim 1, further comprising a window, and wherein the second encoded indicium is hidden from view through the window in an unactivated state of the tilt indicator.

4. The tilt indicator of claim 1, further comprising a window, and wherein the second encoded indicium is hidden from view through the window by the mass member in an unactivated state of the tilt indicator.

5. The tilt indicator of claim 1, further comprising a window, and wherein the first encoded indicium is hidden from view through the window in an activated state of the tilt indicator.

6. The tilt indicator of claim 1, further comprising a window, and wherein the first and second encoded indicia are aligned with the window in an unactivated state of the tilt indicator.

7. The tilt indicator of claim 1, wherein the second encoded indicium is disposed on a forward-facing surface of the back member.

8. A tilt indicator, comprising:
a housing having a face member, a back member, and a window;
a movable mass member disposed within the housing between the face member and the back member, wherein responsive to the tilt indicator being subjected to a tilt event exceeding a threshold, the mass member moves from a first position to a second position;
a first encoded indicium; and
a second encoded indicium, wherein the first and second encoded indicia are aligned with the window in an unactivated state of the tilt indicator.

9. The tilt indicator of claim 8, wherein the second encoded indicium is hidden from view through the window in the unactivated state of the tilt indicator.

10. The tilt indicator of claim 8, wherein the second encoded indicium is hidden from view through the window in the unactivated state of the tilt indicator by the mass member.

11. The tilt indicator of claim 8, wherein the first encoded indicium is located on a forward-facing surface of the mass member.

12. The tilt indicator of claim 8, wherein the second encoded indicium is located on a forward-facing surface of the back member.

13. A tilt indicator, comprising:
a housing having a face member, a back member, and a window;
a movable mass member disposed within the housing between the face member and the back member;
a first encoded indicium disposed on the mass member; and
a second encoded indicium disposed on the back member; and
wherein responsive to the tilt indicator being subjected to a tilt event exceeding a threshold, the mass member moves from a first position to a second position, and wherein either the first encoded indicium or the second encoded indicium is exposed through the window based on a position of the mass member within the housing.

14. The tilt indicator of claim 13, wherein the first encoded indicium is exposed through the window in an unactivated state of the tilt indicator.

15. The tilt indicator of claim 13, wherein the second encoded indicium is exposed through the window in an activated state of the tilt indicator.

16. The tilt indicator of claim 13, wherein the second encoded indicium faces a rearward surface of the mass member in an unactivated state of the tilt indicator.

17. The tilt indicator of claim 13, wherein the second encoded indicium is aligned with the window in an unactivated state of the tilt indicator and in an activated state of the tilt indicator.

18. The tilt indicator of claim 13, wherein the second encoded indicium is disposed on a forward-facing surface of the back member.

19. The tilt indicator of claim 13, wherein at least one of the first and second encoded indicia is a machine-readable barcode.

20. The tilt indicator of claim 13, wherein the first and second encoded indicia are aligned with each other in an unactivated state of the tilt indicator.
